(19) United States
(12) Patent Application Publication
(10) Pub. No.: US 2009/0276491 A1
(43) Pub. Date: Nov. 5, 2009

(54) Management method for remote digital signage

(75) Inventors: Chia-Pin Lin, Hsinchu (TW); Yuan-Shu Hsiao, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/385,899

(22) Filed: Apr. 23, 2009

(30) Foreign Application Priority Data
Apr. 30, 2008 (TW) 097116034

(51) Int. Cl. G06F 15/16

(52) U.S. Cl. 709/204

(57) ABSTRACT

A management method for a remote digital signage provides communication between a web server and the digital signage to make the web server collect a system information from the digital signage. The management method includes the steps of: transmitting a heartbeat every period to the web server by the digital signage; receiving the heartbeat to transmit a reply signal to the digital signage by the web server, wherein the reply signal includes a command; receiving the reply signal to execute the command, and to transmit the system information to the web server by the digital signage; and receiving and storing the system information by the web server.

### BACKGROUND OF THE INVENTION

(1) Field of the Invention

The present invention relates to a management method for a remote digital signage, and particularly to a management method for a remote digital signage with a pull-mode architecture.

(2) Description of the Prior Art

There are two known modes of management for a digital signage, an independent mode and a network mode.

Referring to FIG. 1, in the independent mode, a user 100 controls a digital signage 200 through the OSD (On Screen Display) function of the digital signage 200. Thus, the independent mode is suitable for architecture with a few digital signages 200, but unsuitable for architecture with many digital signages 200 or for a digital signage 200 disposed at high position.

Referring to FIG. 2, the network mode is designed for the efficiency of controlling digital signages 200 and the content displayed thereof. In the network mode, the user 100 controls or updates the content displayed by the digital signages 200 by a sever 300 connecting to the network.

In the network mode, the server 300 manages the digital signages 200 by a push-mode network architecture conventionally. Though easy and convenient, the push-mode network architecture is inappropriate for enterprises. Because in the push-mode network architecture, the server 300 connects to the digital signages 200 via a router or a firewall, it is not only an unsafe method but also a burden for maintenance.

Referring to FIG. 3, a firewall 320 and a router 340 are connected between three digital signages 200 and the server 300 in the network. If the server 300 wants to control the digital signages 200, the server 300 sends packets to the digital signages 200. But the packets are blocked by the firewall 320 first. The user 100 has to close the protection of the firewall 320, so the risk of the network increases. Even though the packets pass the firewall 320, the packets are still blocked because the router 340 has no idea to distribute the packets to which digital signage 200. It is necessary to modify the configuration of the router 340 to make each packet reach the target digital signage 200, which increases complexity of the network.

In another way of managing the digital signages 200 in the network mode, a web server is installed in each digital signage 200. So that the user 100 may connect the web server directly to set the digital signage 200. Though this method costs lower, it controls only one digital signage 200 each time and works only in closed local area network (LAN). If the user 100 wants to control the digital signages 200 through internet, the configuration of the network equipment is necessarily modified, or a virtual private network (VPN) is necessarily established, and the cost of the network architecture is again raised.

### SUMMARY OF THE INVENTION

One object of the present invention is to provide a management method with more expansibility and safety in network for a remote digital signage.

For one or part of or all objectives mentioned or other objectives, one embodiment of the management method for the remote digital signage of the present invention provides communication between a web server and the digital signage. In the management method, the web server collects the system information of the digital signage. The method includes the steps of: transmitting a heartbeat to the web server every period by the digital signage; receiving the heartbeat to transmit a reply signal to the digital signage by the web server, wherein the reply signal includes a command; receiving the reply signal to execute the command, and to transmit a system information of the digital signage to the web server by the digital signage; and receiving and storing the system information by the web server.

one embodiment of the management method further includes the step of: determining by the web server whether the digital signage is disconnected to the web server or not by determining whether the difference of time between the two adjacent heartbeats is larger than the period or not.

Each of the heartbeat, the reply signal and the system information has a packet format, and the packet format is a format of eXtensible Markup Language (XML), and is transmitted in internet by Hyper Text Transmission Protocol (HTTP). The command is a GET command or a SET command. The digital signage executes the GET command to collect the system information, and executes the SET command to set the system information to generate an updated system information. After the setting, the digital signage transmits the updated system information to the web server.

Moreover, the management method further includes a transfer node disposed between the web server and the digital signage. The step of transmitting the reply signal to the digital signage by the web server includes the steps of: transmitting the reply signal to the transfer node by the web server and storing the reply signal in the transfer node; and receiving the heartbeat and transmitting the reply signal to the digital signage by the transfer node. The step of executing the command to transmitting the system information to the web server by the digital signage includes the steps of: transmitting the system information to the transfer node by the digital signage; and transmitting the system information to the web server by the transfer node.

Another embodiment of the present invention provides a management method for a remote digital signage including the steps of: transmitting a first heartbeat to the web server by the digital signage; receiving the first heartbeat to transmit a first command to the digital signage by the web server; executing the first command to transmit a first system information to the web server by the digital signage; storing the first information system in the web server; determining by the digital signage whether there is a second command following the first command according to the first command; if the second command exists, transmitting a second heartbeat to the web server by the digital signage; receiving the second heartbeat go transmit the second command to the digital signage by the web server; executing the second command to transmit a second system information to the web server by the digital signage; and storing the second system information in the web server.

In one embodiment of a management method, each of the first heartbeat, the second heartbeat, the first command, the second command, the first system information, and second system information has a packet format, and the package format is a format of XML, and is transmitted in internet by HTTP.

one embodiment of the management method further comprising the step of: determining by the web server whether the digital signage is disconnected to the web server or not by determining whether the difference of time between the first heartbeat and the second heartbeat is larger than a predetermined time or not.

Overall, the digital signage communicates with the web server by HTTP. Without modifying the configuration of the firewall and the router, the web server still manages and controls a large number of digital signages across the world, so the method in the embodiment is convenient and cost-saving.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional management architecture for a digital signage with the independent mode.

FIG. 2 is a schematic view of a conventional management architecture for digital signages with the network mode.

FIG. 3 is a schematic view of a conventional management architecture for digital signages with the push-mode network.

FIG. 4 is a schematic view of an embodiment of a pull-mode network architecture according to the present invention.

FIG. 5 is a schematic view of an embodiment of a pull-mode network architecture according to the present invention.

FIG. 6 is a schematic view showing a signal transmission method between a web server and a digital signage in an embodiment of a pull-mode network architecture according to the present invention.

FIG. 7 is a schematic view showing a signal transmission method between a web server and a digital signage in an embodiment of a pull-mode network architecture according to the present invention.

FIG. 8 is a schematic view showing a signal transmission method between a web server and a digital signage in an embodiment of a pull-mode network architecture according to the present invention.

FIG. 9 is a schematic view showing a signal transmission method between a web server and a digital signage in an embodiment of a pull-mode network architecture according to the present invention.

FIG. 10 is a schematic view showing a signal transmission method between a web server and a digital signage in an embodiment of a pull-mode network architecture according to the present invention.

FIG. 11 is a flow chart of the management method for the remote digital signage in an embodiment according to the present invention.

FIG. 12 is a schematic view of an embodiment of a pull-mode network architecture according to the present invention.

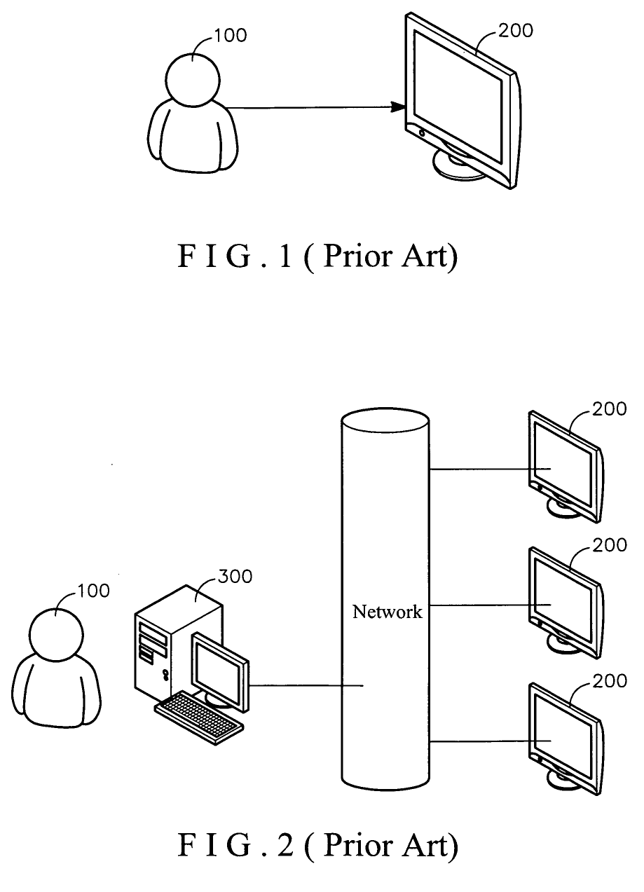

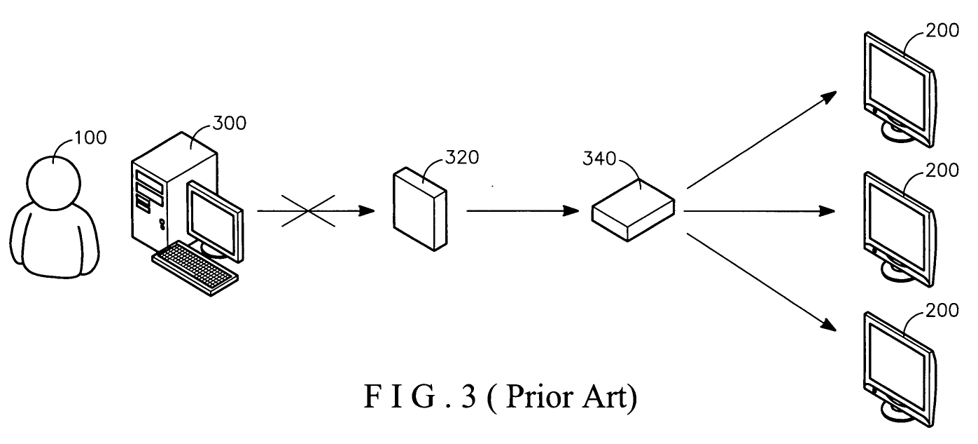

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

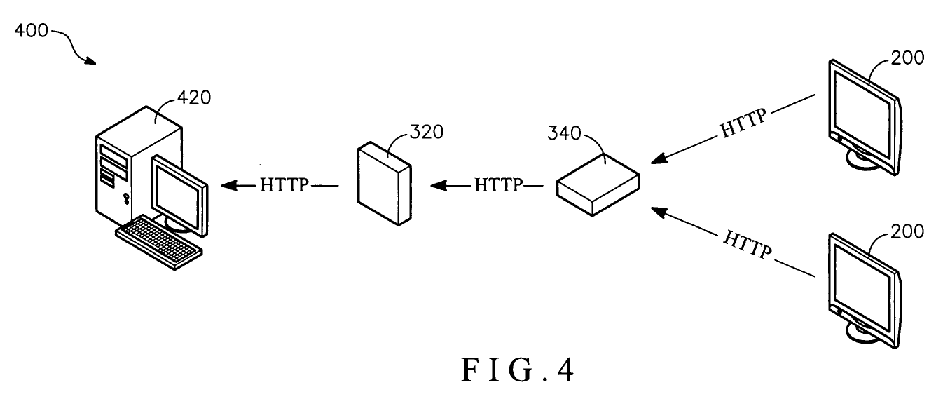

Referring to FIG. 4, in network, the packet of Hyper Text Transmission Protocol passes through network equipments like a firewall 320 or a router 340 to connect a web server 420 without blocks. One embodiment of the invention introduces a pull-mode network architecture 400. The digital signage 200 is regarded as a client of the web server 420. The digital signage 200 communicates with the web server 420 by HTTP to overcome the blocks of network equipments. In this way, an network architecture for managing the remote digital signage 200 is formed.

In the pull-mode network architecture 400, the web server 420 is a passive end and the digital signage 200 is an active end. In other words, the web server 420 does not send commands to the digital signage 200 actively but only responds to the messages transmitted from the digital signage 200 passively. However, the digital signage 200 transmits messages to the web server 420 actively. In this embodiment, the digital signage 200 transmits a heartbeat to the web server 420 every period. The web server 420 reads the heartbeat, determines whether the digital signage 200 is online or not, and transmits a reply signal to the digital signage 200 in response to the heartbeat to perform the function of controlling the digital signage 200.

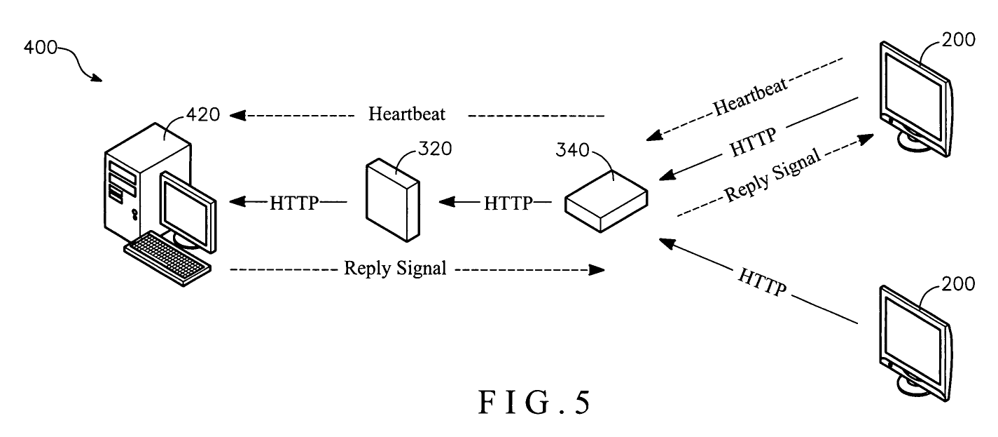

FIG. 5 shows the transmission directions of the heartbeats from the digital signages 200 and the transmission directions of the reply signals from the web server 420. The present embodiment packages the heartbeat and the reply signal between the web server 420 and the digital signage 200 into one or plural packets by Simple Object Access Protocol (SOAP). In the SOAP, the packets are packaged in format of eXtensible Markup Language (XML), so that the web server 420 and the digital signage 200 read the messages inside the packets easily. Furthermore, the packets in format of XML are able to be transmitted and interpreted by different program languages, platforms and hardware. The expansibility of the network architecture 400 is increased.

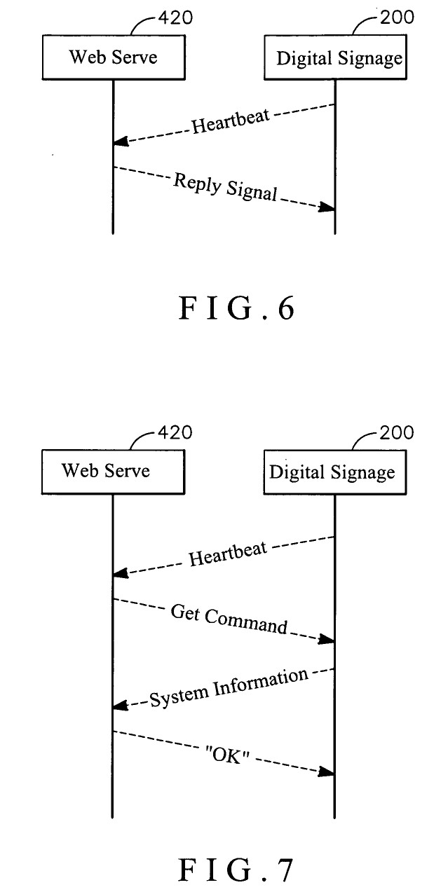

Referring to FIG. 6, in this embodiment, the heartbeat plays an role of communication between the digital signage 200 and the web server 420. The digital signage 200 transmits the heartbeat to the web server 420 every predetermined period. The web server 420 transmits a reply signal including a status message or a command to the digital signage 200 in response to the heartbeat by HTTP. On the other hand, by determining whether the difference of time between the two adjacent heartbeats is larger than the predetermined period, the web server 420 determines whether the digital signage 200 is disconnected to the web server 420 or not. The heartbeat contains a parameter of StatusFlag to record the status of the digital signage 200 such as a playing status. Thus by reading the heartbeat, the web server 420 gets the status of the digital signage 200.

Referring to FIG. 7, the web server 420 uses two kinds of commands to control the digital signage 200, a SET command and a GET command. The SET command is used to set the status of the digital signage 200. The GET command is used to get the current system information of the digital signage 200.

Referring to FIG. 7, the digital signage 200 transmits a heartbeat to inform the web server 420 about the current basic status of the digital signage 200. After receiving the heartbeat, the web server 420 checks a database thereof and finds a requiring of the system information of the digital signage 200. The web server 420 transmits a reply signal including the GET command, such as a packet with a parameter of GetSysInfo, to the digital signage 200 in response to the heartbeat. After receiving the reply signal, the digital signage 200 collects the relevant system information and then transmits the system information back to the web server 420. The web server 420 receives and stores the system information in the database thereof, and responds OK status message to the digital signage 200. A getting action is completed. Remarkably, the getting action has no relation with the next heartbeat.

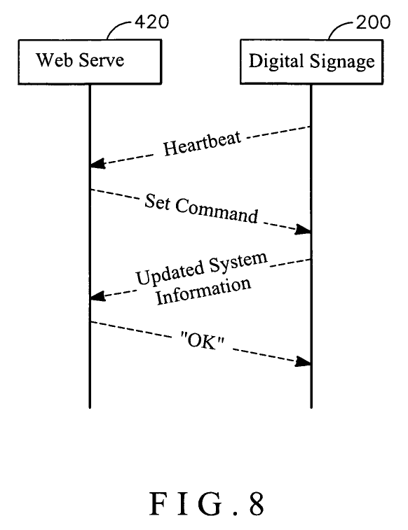

Referring to FIG. 8, after receiving the heartbeat from the digital signage 200, the web server 420 transmits a reply signal including a SET command containing a parameter of SetplayerName to the digital signage 200 in response to the heartbeat. The digital signage 200 receives the SET command and sets the name of the signage 200 according to the parameter. Subsequently, the digital signage 200 transmits an updated system information to the web server 420, so that the web server 420 gets the status of the digital signage 200 after the digital signage 200 executes the SET command. After updating the database of the web server 420, the web server 420 responds an OK status message to the digital signage 200. A setting action is completed.

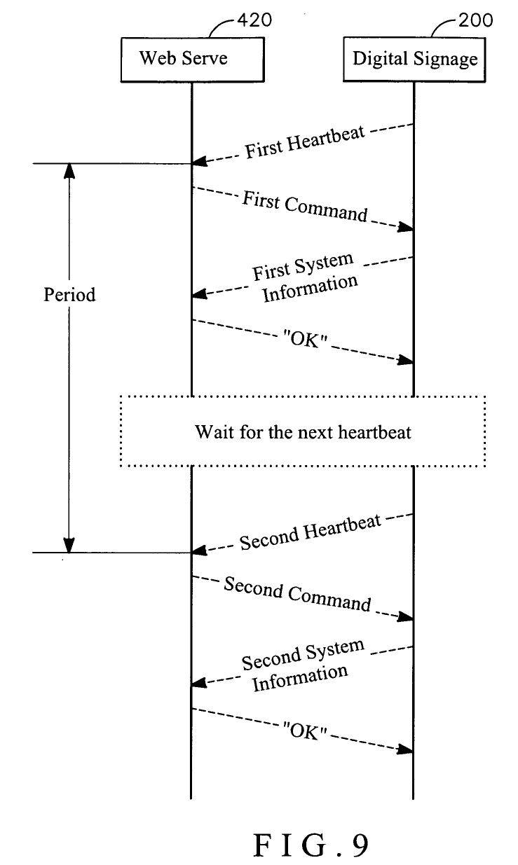

Referring to FIG. 9, the web server 420 provides a plurality of commands for executing continuously. By reason that every command is transmitted to the digital signage 200 after the web server 420 receives the heartbeat from the digital signage 200, the transmitting between the two continuous commands is delayed if the digital signage 200 transmits only one heartbeat to the web server 420 every period.

Referring to FIG. 9, actions of the first command and the second command have to execute continuously. After the digital signage 200 transmits a first heartbeat to the web server 420, the web server 420 receives the first heartbeat and transmits the first command to the digital signage 200. The digital signage 200 executes the first command and provides a first system information to the web server 420. After the web server 420 receives the first system information and responds an OK status message to the digital signage 200, the first command is completed. Then, after the web server 420 waits for a period, the digital signage 200 transmits a second heartbeat to the web server 420 and the web server 420 receives the second heartbeat and transmits the second command to the digital signage 200. The digital signage 200 executes the second command and provides a second system information to the web server 420. After the web server 420 receives the second system information and responds an OK status message to the digital signage 200, the second command is completed.

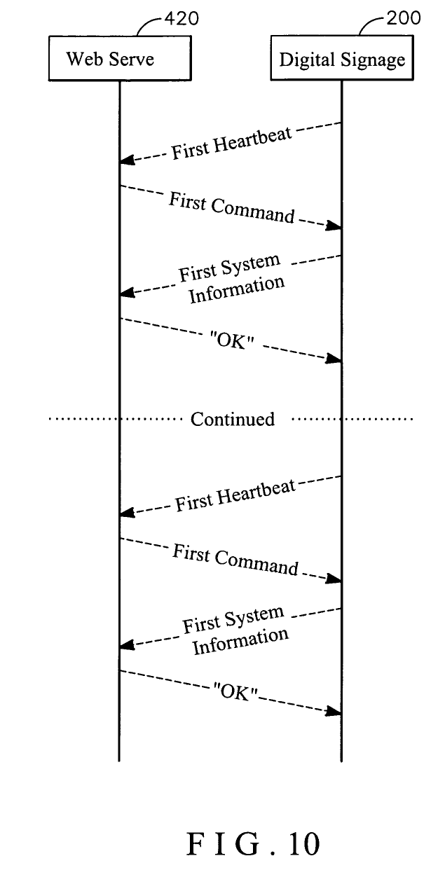

Referring to FIG. 10, to shorten the waiting time of the digital signage 200 for the second command, a parameter of ContinueCMD is added in the first command responding to the digital signage 200 by the web server 420. This parameter lets the digital signage 200 transmit the second heartbeat immediately after the first command is completed and receive and execute the second command without waiting for a period. Moreover, the digital signage 200 determines whether there is a second command following the first command according to the first command. In this way, the total time of continuous commands transmitting to the digital signage 200 is saved and the command timeliness may be raised.

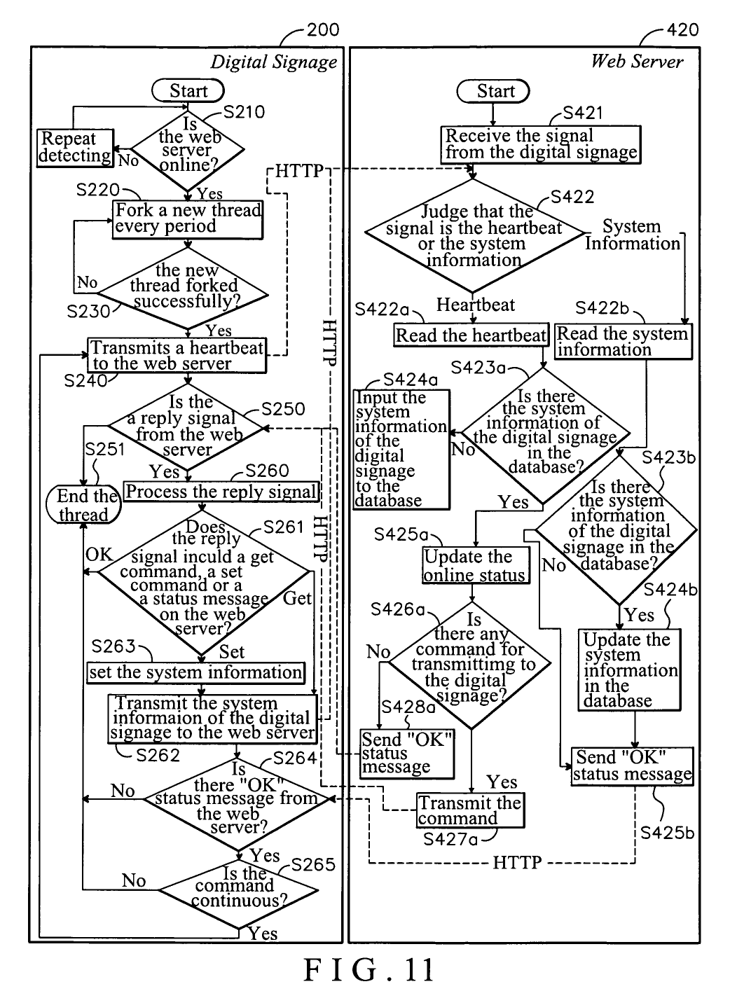

Referring to FIG. 11, the digital signage 200 detects whether the web server 420 is online every few seconds in step S210. If the web server 420 is online, the digital signage 200 forks a new thread every few seconds in step S220. Each new thread contains a step of transmitting a new heartbeat. Then, the digital signage 200 determines whether the new thread is forked successfully in step S230. If the new thread is forked successfully in step S230, the digital signage 200 transmits a heartbeat to the web server 420 in step S240. Subsequently, the digital signage 200 determines whether the web server 420 responds a reply signal in step S250. The reply signal contains a GET command, a SET command or a status message of the web server 420, such as an OK status message. If the digital signage 200 does not receive any reply signal, the thread is ended in step S251, If the digital signage 200 receives any reply signal, the digital signage 200 processes the reply signal in step S260.

The step of processing the reply signal by the digital signage 200 in step S260 includes following steps: determining by the digital signage 200 whether the reply signal includes the GET command, the SET command or the status message of the web server 420 in step S261; transmitting the system information to the web server by the digital signage 200 if the reply signal includes the GET command in step S262; setting the system information of the digital signage 200 if the reply signal includes the SET command in step S263, and transmitting the setting system information to the web server 420 in step S262; ending the thread if the reply signal includes an OK status message in step S251; determining by the digital signage 200 whether there is an OK status message from the web server 420 after transmitting the system information to the web server 420 if the reply signal includes the GET command or the SET command in step S264; ending the thread by the digital signage 200 if there is no OK status message in step S251; determining by the digital signage 200 whether the GET command or the SET command in the reply signal is continuous command, such as a command with a parameter of ContinueCMD, if there is an OK status message in step S265. and transmitting another new heartbeat to the web server 420 immediately by the digital signage 200 if the command is continuous in step S240; and ending the thread by the digital signage 200 if the command is continuous in step S251.

The web server 420 receives the heartbeat or the system information from the digital signage 200 in step S421 and determines the received message in step S422. If the received message is a heartbeat, the web server 420 reads the heartbeat in step S422a and checks the database for the system information of the digital signage 200 in step S423a. If there is no system information of the digital signage 200 in the database, the web server 420 inputs the system information of the digital signage 200 to the database in step S424a. If there is a system information of the digital signage 200 in the database, the web server 420 updates the online status in step S425a. Then the web server 420 determines whether there is a command for transmitting to the digital signage 200 in step S426a. If there is any command for transmitting to the digital signage 200, the web server 420 transmits the command in step S427a. If there is no command for transmitting to the digital signage 200, the web server 420 transmits an OK status message (S428a).

After step S422, if the received message is a system information, the web server 420 reads the system information in step S422b and checks whether there is a system information of the digital signage 200 in the database in step S423b. If there is a system information of the digital signage 200 in the database, the web server 420 updates the system information in the database in step S424b and replies an OK status message to the digital signage 200 in step S425b. If there is no system information of the digital signage 200 in the database, the web server 420 replies an OK status message directly to the digital signage 200 in step S425b.

In the embodiment, the user manages digital signages 200 disposed at different places across the world without changing configuration of network equipment. By performing the management method for a remote digital signage in the embodiment with a database and a distributive operation system, the number of digital signages 200 may increase with the improved operation ability of the web server 420.

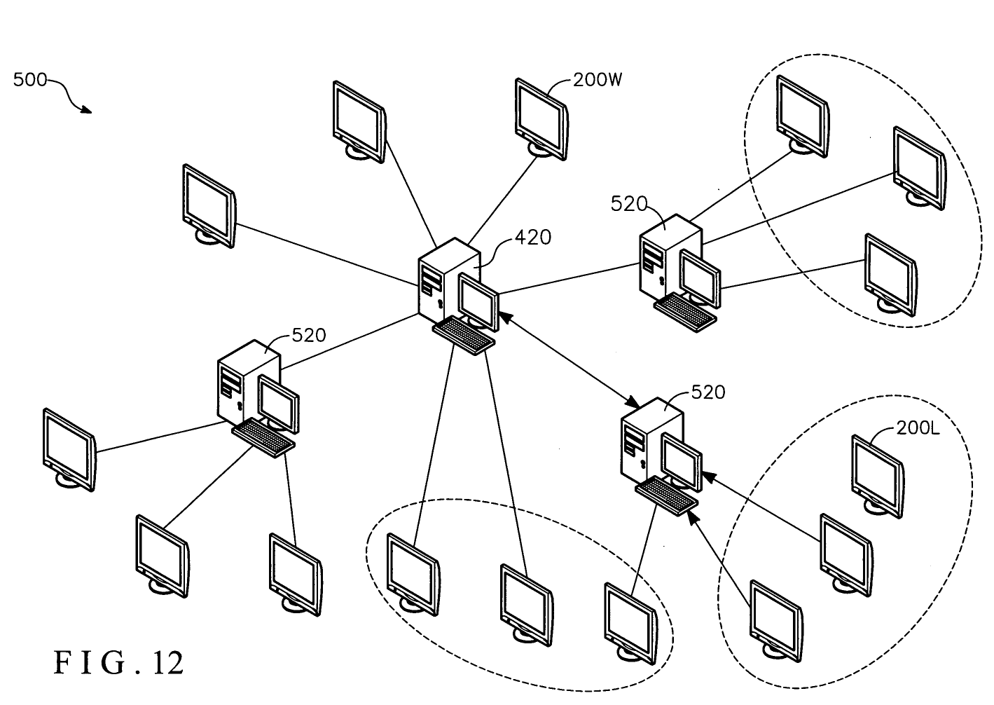

Refer to FIG. 12, the network architecture 500 of the embodiment is extended from the network architecture 400 by adding transfer nodes 520. The transfer node 520 balances the operation load in the web server 420 and connects to a digital signage 200L in LAN or a digital signage 200W in internet.

With the transfer node 520, the heartbeats of the digital signages 200L, 200W are not executed by the web server 420 every time. Only when the system information or online statuses of the digital signages 200L, 200W are changed, the transfer node 520 transmits system information to the web server 420. In this embodiment, there is a two-way communication between the web server 420 and the transfer node 520. The web server 420 transmits signals to the transfer node 520 actively, and the transfer node 520 transmits signals to the web server 420 actively. There is a one-way communication between the transfer node 520 and the digital signages 200L, 200W. Only the digital signages 200L, 200W transmit signals to the transfer node 520 actively, while the transfer node 520 responds to the digital signages 200L, 200W passively.

When the web server 420 intends to transmit commands to the digital signages 200L, 200W, the commands are transmitted to the transfer node 520. The transfer node 520 stores the commands until receiving the heartbeats from the digital signages 200L, 200W. Then the transfer node 520 transmits the commands to the digital signages 200L, 200W. With this mechanism, a large part of the internet flow between the web server 420 and the digital signages 200L, 200W is processed by the transfer node 520 so as to reduce the load of bandwidth and data processing of the web server 420.

In this embodiment, by the network architecture of the single web server 420, the number of the managed digital signages 200L, 200W are extended unlimitedly in theory when using distributive operation and network balance mechanism. With HTTP and Secure Sockets Layer (SSL), communication data is encrypted to avoid reveal.

The digital signages 200L, 200W are communicated with the web server 420 by HTTP. Without modifying the configuration of the firewall 320 and the router 340, the web server 420 still manages and controls the digital signages 200L, 200W across the world. The method in the embodiment is convenient and cost-saving for those enterprises with a large number of digital signages 200L, 200W across the world. Besides, the method in the embodiment is suitable for the closed environment with a few of digital signages 200L, 200W.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A management method for a remote digital signage, for communication between a web server and the digital signage and collecting a system information from the digital signage by the web server, comprising the steps of:
transmitting a heartbeat every period to the web server by the digital signage;
receiving the heartbeat by the web server to transmit a reply signal to the digital signage, wherein the reply signal comprises a command;
executing the command by the digital signage to transmit the system information of the digital signage to the web server; and
storing the system information in the web server.

2. The management method for the remote digital signage of claim 1, wherein each of the heartbeat, the reply signal, and the system information has a packet format, and the packet format is a format of extensible markup language.

3. The management method for the remote digital signage of claim 1, further comprising the step of: determining by the web server whether the digital signage is disconnected to the web server or not by determining whether the difference of time between the two adjacent heartbeats is larger than the period or not.

4. The management method for the remote digital signage of claim 1, wherein the command is a getting command, and the digital signage executes the getting command to collect the system information.

5. The management method for the remote digital signage of claim 1, wherein the command is a setting command, the digital signage executes the setting command to set the system information to generate an updated system information, and the digital signage transmits the updated system information to the web server.

6. The management method for the remote digital signage of claim 1, further comprising the step of: providing a transfer node disposed between the web server and the digital signage, wherein the step of transmitting the reply signal to the digital signage by the web server comprises the steps of:
transmitting the reply signal to the transfer node by the web server, and storing the reply signal in the transfer node; and
receiving the heartbeat and transmitting the reply signal to the digital signage by the transfer node.

7. The management method for the remote digital signage of claim 6, wherein the step of executing the command to transmit the system information to the web server by the digital signage comprises the steps of:
transmitting the system information to the transfer node by the digital signage; and
transmitting the system information to the web server by the transfer node.

8. The management method for the remote digital signage of claim 1, wherein the web server is communicated with the digital signage by hyper text transmission protocol.

9. A management method for a remote digital signage, for communication between a web server and the digital signage, comprising the steps of:
transmitting a first heartbeat to the web server by the digital signage;
receiving the first heartbeat to transmit a first command to the digital signage by the web server;
executing the first command to transmit a first system information to the web server by the digital signage;
storing the first information system in the web server;
determining by the digital signage whether there is a second command following the first command according to the first command;
transmitting a second heartbeat to the web server by the digital signage, if the second command exists;
receiving the second heartbeat to transmit the second command to the digital signage by the web server;
executing the second command to transmit a second system information to the web server by the digital signage; and
storing the second system information in the web server.

10. The management method for the remote digital signage of claim 9, wherein each of the first heartbeat, the second heartbeat, the first command, the second command, the first system information, and the second system information has a packet format, and the packet format is a format of extensible markup language.

11. The management method for the remote digital signage of claim 9, further comprising the step of: determining by the web server whether the digital signage is disconnected to the web server or not by determining whether the difference of time between the first heartbeat and the second heartbeat is larger than a predetermined time or not.

12. The management method for the remote digital signage of claim 9, further comprising the step of: providing a transfer node disposed between the web server and the digital signage, wherein step of transmitting the first command to the digital signage by the web server comprises the steps of:
transmitting the first command to the transfer node by the web server and storing the first command in transfer node; and
receiving the first heartbeat to transmit the first command to the digital signage by the transfer node.

13. The management method for the remote digital signage of claim 12, wherein the step of executing the first command to transmit the first system information to the web server by the digital signage comprises the steps of:
transmitting the first system information to the transfer node by the digital signage; and
transmitting the first system information to the web server by the transfer node.

14. The management method for the remote digital signage of claim 12, wherein the step of transmitting the second command to the digital signage by the web server comprises the steps of:
transmitting the second command to the transfer node by the web server, and storing the second command in the transfer node; and
receiving the second heartbeat to transmit the second command to the digital signage by the transfer node.

15. The management method for the remote digital signage of claim 14, wherein the step of executing the second command to transmit the second system information to the web server by the digital signage comprises the steps of:
transmitting the second system information to the transfer node by the digital signage; and
transmitting the second system information to the web server by the transfer node.

16. The management method for the remote digital signage of claim 9, wherein the web server is communicated with the digital signage by hyper text transmission protocol.
